(19) United States
(12) Patent Application Publication
(10) Pub. No.: US 2018/0128633 A1
(43) Pub. Date: May 10, 2018

(54) Navigation System and Control Method for Navigation System

(71) Applicant: TOYOTA JIDOSHA KABUSHIKI KAISHA, Toyota-shi (JP)

(72) Inventor: Rie MURAI, Chiba-shi (JP)

(73) Assignee: TOYOTA JIDOSHA KABUSHIKI KAISHA, Toyota-shi (JP)

(21) Appl. No.: 15/783,357

(22) Filed: Oct. 13, 2017

(30) Foreign Application Priority Data
Nov. 4, 2016 (JP) 2016-216321

(51) Int. Cl. G01C 21/36; G08G 1/0968; G01C 21/34

(52) U.S. Cl. CPC G01C 21/3617; B60W 2540/28; G01C 21/3484; G08G 1/096838

(57) ABSTRACT

A navigation system includes: a destination determination unit that determines whether or not the destination of a vehicle is a destination frequently traveled by a driver of the vehicle based on a traveling history of the vehicle; a fixed route calculation unit that calculates a fixed route that is a route based on static factors, among the static factors that do not change with time and dynamic factors that change with time all of which are factors that determine the road environment, as a traveling route of the vehicle from a departure point toward a destination when the destination determination unit determines that the destination of the vehicle is the destination frequently traveled by the driver of the vehicle; and a route output unit that outputs the fixed route calculated by the fixed route calculation unit as a guide route of the vehicle.

### INCORPORATION BY REFERENCE

The disclosure of Japanese Patent Application No. 2016-216321 filed on Nov. 4, 2016 including the specification, drawings and abstract is incorporated herein by reference in its entirety.

### BACKGROUND

### 1. Technical Field

The present disclosure relates to a navigation system for guiding a route of a vehicle and a control method for a navigation system.

### 2. Description of Related Art

As an example of this kind of navigation system, a navigation system disclosed in Japanese Unexamined Patent Application Publication No. 10-132599 (JP 10-132599 A) calculates a second route in consideration of traffic information while performing vehicle route guidance according to a first route without considering traffic information. Then, the navigation system predicts the driving time of the vehicle when traveling on each route, and presents the second route to the driver as an alternative to the first route when the driving time of the second route is shorter than the driving time of the first route.

### SUMMARY

However, since the above-described navigation system calculates the second route according to the traffic information at that time, a possibility that the route presented to the driver is different for each calculation is high. Therefore, when the driver is especially an elderly person, the driver may feel uneasy about traveling on a different route at that time.

A first aspect of the disclosure relates to a navigation system including a destination determination unit, a fixed route calculation unit, and a route output unit. The destination determination unit is configured to determine whether or not the destination of a vehicle is a destination frequently traveled by a driver of the vehicle based on a traveling history of the vehicle. The fixed route calculation unit is configured to calculate a fixed route that is a route based on static factors, among the static factors that do not change with time and dynamic factors that change with time, all of which are factors that determine the road environment, as a traveling route of the vehicle from a departure point toward a destination when the destination determination unit determines that the destination of the vehicle is the destination frequently traveled by the driver of the vehicle. The route output unit is configured to output the fixed route calculated by the fixed route calculation unit as a guide route of the vehicle.

According to the first aspect of the disclosure, a fixed route calculated based on the static factors of the road environment that do not change with time is presented as a guide route of the vehicle heading for the destination of the vehicle. The fixed route is calculated as a traveling route that does not change according to the dynamic factors of the road environment, such as congestion information, traffic control information, and accident information. Therefore, by repeatedly presenting the fixed route as a guide route of the vehicle heading for the destination frequently traveled by the driver of the vehicle, the traveling of the vehicle along the fixed route can be recognized by the driver.

The navigation system according to the first aspect of the disclosure may further include a destination estimation unit and a fixed route storage unit. The destination estimation unit is configured to estimate the destination of the vehicle based on an activity history of the driver of the vehicle. The fixed route storage unit is configured to store the fixed route calculated by the fixed route calculation unit. The destination determination unit may be configured to determine whether or not the estimated destination is the destination frequently traveled by the driver each time destination estimation is performed by the destination estimation unit. The fixed route calculation unit may be configured to store the fixed route in the fixed route storage unit as a traveling route of the vehicle from the departure point toward the destination when the destination determination unit determines that the destination estimated by the destination estimation unit is the destination frequently traveled by the driver. The route output unit may be configured to read the fixed route from the fixed route storage unit and output the read fixed route as a guide route of the vehicle when a combination of a departure point and a destination when a destination of the vehicle is set by the driver of the vehicle matches a combination of a departure point and a destination of the vehicle in the fixed route stored in the fixed route storage unit.

According to the first aspect of the disclosure, the destination of the vehicle is estimated based on the activity history of the driver of the vehicle, such as schedule information, dialogue input information, and the traveling history of the vehicle. Then, each time the destination of the vehicle is estimated, whether or not the estimated destination is a destination frequently traveled by the driver is determined, and the fixed route is calculated and stored in the fixed route storage unit as needed. Therefore, compared with a configuration in which fixed route calculation processing is performed exclusively when the destination of the vehicle is actually set, fixed routes are stored in the fixed route storage unit for various combinations of the departure point and the destination of the vehicle. As a result, since the combination of the departure point and the destination of the vehicle when the destination of the vehicle is set is easy to match the combination of the departure point and the destination of the vehicle on the fixed route, the traveling of the vehicle along the fixed route can be recognized by the driver for a wide range of combinations of the departure point and the destination of the vehicle.

In the navigation system according to the first aspect of the disclosure, the fixed route calculation unit may be configured to store the fixed route or a plurality of the fixed routes based on the static factors in the fixed route storage unit as a traveling route of the vehicle from the departure point toward the destination when the destination determination unit determines that the destination of the vehicle is the destination frequently traveled by the driver. The route output unit may be configured to determine ease of traveling of the vehicle based on the dynamic factors for the plurality of the fixed routes, read the fixed route determined to be relatively easy in traveling from the fixed route storage unit, and output the read fixed route as a guide route of the vehicle when the plurality of the fixed routes is stored in the fixed route storage unit as traveling routes of the vehicle from the departure point toward the destination when the destination of the vehicle is set by the driver of the vehicle.

According to the first aspect of the disclosure, when a plurality of fixed routes is stored in the fixed route storage unit as traveling routes of the vehicle from the departure point toward the destination when the destination of the vehicle is determined to be a destination frequently traveled by the driver, the traveling of the vehicle along the fixed route presented according to the dynamic factors of the road environment at that time can be recognized by the driver.

In the navigation system according to the first aspect of the disclosure, the dynamic factors for the plurality of the fixed routes may be traffic information in each of the plurality of the fixed routes, and may include at least one of congestion information, traffic control information, and accident information.

In the navigation system according to the first aspect of the disclosure, the fixed route calculation unit may be configured to calculate a first fixed route, as a traveling route of the vehicle from the departure point toward the destination when the destination determination unit determines that the destination of the vehicle is the destination frequently traveled by the driver, based on the static factors and calculate a second fixed route different from the first fixed route based on the static factors when a frequency of reading the first fixed route by the route output unit reaches a predetermined threshold value.

According to the first aspect of the disclosure, the first fixed route is calculated first as a route that does not change according to the dynamic factors of the road environment, and the calculated first fixed route is repeatedly presented to the driver as a guide route of the vehicle. Then, when the frequency of presentation of the first fixed route reaches a predetermined threshold value, the fixed route calculation unit determines that the first fixed route has been sufficiently recognized by the driver, and calculates the second fixed route as a route different from the first fixed route based on the static factors of the road environment and presents the calculated second fixed route to the driver. As a result, the traveling of the vehicle along various fixed routes as traveling routes of the vehicle toward the destination determined to be frequently traveled by the driver can be sequentially recognized by the driver.

In the navigation system according to the first aspect of the disclosure, the traveling history of the vehicle may be periodically uploaded from the vehicle to a driver information database.

A second aspect of the disclosure relates to a control method for a navigation system including: estimating a destination of a vehicle based on an activity history of a driver of the vehicle that is stored in a driver information database; acquiring a facility use history of the driver from an external server; determining whether or not the estimated destination of the vehicle is a destination frequently traveled by the driver of the vehicle; calculating a fixed route that is a route based on static factors, among the static factors that do not change with time and dynamic factors that change with time, all of which are factors that determine a road environment, as a traveling route of the vehicle from a departure point toward a destination when the estimated destination of the vehicle is determined to be the destination frequently traveled by the driver of the vehicle; and storing the fixed route in the driver information database.

The control method according to the second aspect of the disclosure may further include: determining whether or not the driver is a driver for whom presentation of a fixed route is needed; and in a case where the driver is a driver for whom presentation of the fixed route is needed, when there is a fixed route corresponding to the departure point and the destination of the vehicle, acquiring the fixed route and presenting the fixed route to the driver.

In the control method according to the second aspect of the disclosure, the control method may further include: determining whether or not there is a plurality of fixed routes corresponding to the destination; acquiring traffic information corresponding to each fixed route from an external server in a case where there is a plurality of fixed routes corresponding to the destination; and selecting a fixed route from the plurality of fixed routes based on the traffic information, acquiring the selected fixed route from the driver information database, and presenting the acquired fixed route to the driver.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating the schematic configuration of a first embodiment of a navigation system;

FIG. 2 is a schematic diagram showing an example of the data content of a fixed route;

FIG. 3 is a flowchart showing the content of fixed route calculation processing executed by the navigation system of the present embodiment;

FIG. 4 is a flowchart showing the content of guide route presentation processing executed by a navigation device mounted in a vehicle in cooperation with the navigation system of the present embodiment;

FIG. 5 is a block diagram illustrating the schematic configuration of a second embodiment of a navigation system;

FIG. 6 is a schematic diagram showing an example of the data content of a fixed route;

FIG. 7 is a flowchart showing the content of fixed route calculation processing executed by the navigation system of the present embodiment; and

FIG. 8 is a flowchart showing the content of guide route presentation processing executed by a navigation device mounted in a vehicle in cooperation with the navigation system of the present embodiment.

### DETAILED DESCRIPTION OF EMBODIMENTS

### First Embodiment

Hereinafter, a first embodiment of a navigation system will be described. When a driver who is likely to feel uneasy about his or her memory, such as an elderly person, drives a vehicle, the navigation system of the present embodiment presents a fixed route based on the static factors of the road environment as a guide route of the vehicle heading for a destination frequently traveled by the driver. As a result, the traveling of the vehicle along the fixed route is suitably recognized by the driver.

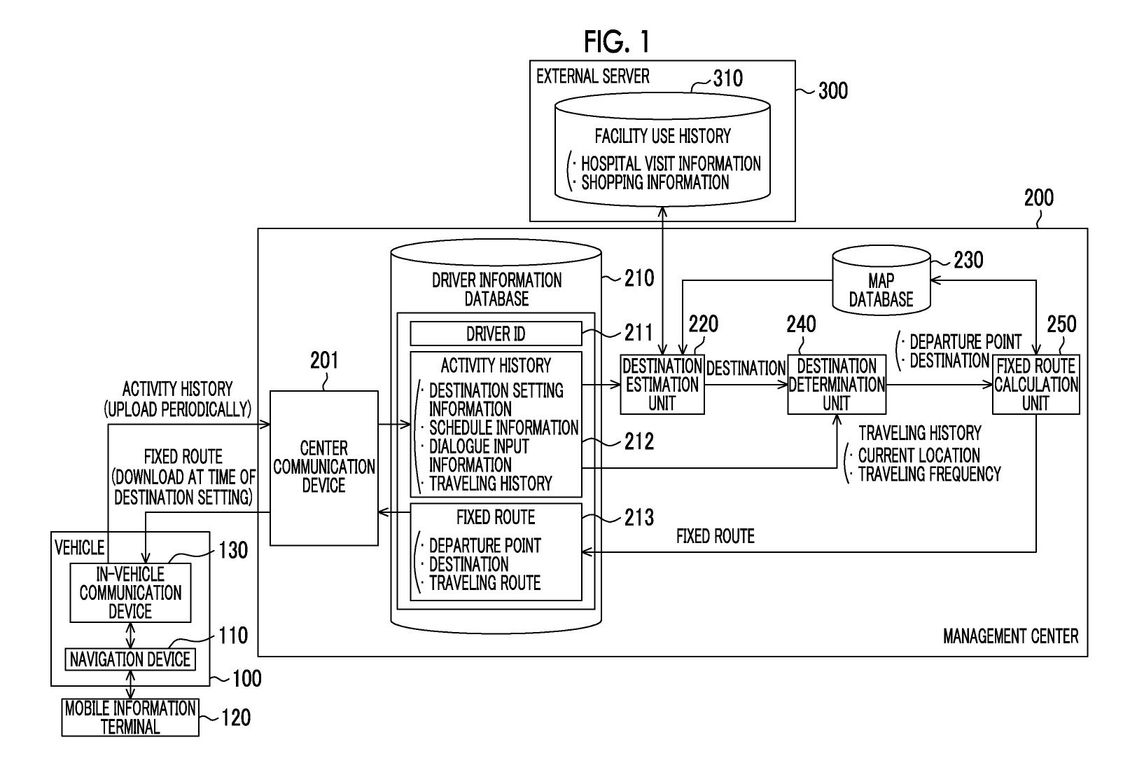

Specifically, as shown in FIG. 1, a vehicle 100 includes a navigation device 110 as an example of a route display device for guiding the route of the vehicle 100. A global position system (GPS) sensor for acquiring the position information of the vehicle 100 at that time is mounted in the navigation device 110. By recording the position information acquired through the GPS sensor as a log, the navigation device 110 acquires information regarding the traveling history of the vehicle 100 as the driver's activity history. The navigation device 110 has a short-range wireless communication function based on a communication scheme, such as Bluetooth (registered trademark), so that the driver's schedule information or the like is acquired as the driver's activity history from a mobile information terminal 120 owned by the driver of the vehicle 100. The navigation device 110 has a voice dialogue function, so that dialogue input information input in a dialogue including chat with the driver of the vehicle 100 is acquired as the driver's activity history. The vehicle 100 periodically uploads the driver's activity history acquired through the navigation device 110 as described above to a management center 200, which manages traveling information of a plurality of vehicles 100, through an in-vehicle communication device 130.

On the other hand, the management center 200 receives an activity history 212 of the driver uploaded from the vehicle 100, through a center communication device 201, in association with a driver ID 211 that is identification information set for each driver of the vehicle 100, and stores the activity history 212 in a driver information database 210. The driver information database 210 may function as a fixed route storage unit

In the management center 200, a destination estimation unit 220 estimates the destination of the vehicle 100 by periodically reading the activity history 212 stored in the driver information database 210. In this case, when destination setting information set by the driver of the vehicle 100 through the navigation device 110 is included in the activity history 212, the destination estimation unit 220 estimates the destination of the vehicle 100 based on the destination setting information. When the driver's schedule information relevant to the setting of the destination is included in the activity history 212, the destination estimation unit 220 estimates the destination of the vehicle 100 based on the schedule information. When the driver's dialogue input information relevant to the setting of the destination is included in the activity history 212, the destination estimation unit 220 estimates the destination of the vehicle 100 based on the dialogue input information. When the above-described destination setting information and the driver's schedule information or the driver's dialogue input information relevant to the setting of the destination are not included in the activity history 212, the destination estimation unit 220 estimates the destination of the vehicle 100 based on information regarding the traveling history of the vehicle 100 included in the activity history 212.

The destination estimation unit 220 acquires a facility use history 310 of the driver of the vehicle 100 from an external server 300 with reference to the driver ID 211 associated with the activity history 212 in the driver information database 210. Examples of the facility use history 310 include information regarding the name of a hospital visited and information regarding the name of a store used for shopping.

The destination estimation unit 220 determines the position coordinates on the map data regarding the destination of the vehicle 100 estimated based on the activity history 212 and the position coordinates on the map data regarding facilities that the driver has used in the past based on the facility use history 310 with reference to a map database 230. Then, when the determined position coordinates match each other, the destination estimation unit 220 outputs an estimation result of the destination of the vehicle 100 to a destination determination unit 240, and the destination determination unit 240 determines whether or not the destination of the vehicle 100 is a destination frequently traveled by the driver.

In the determination, the destination determination unit 240 analyzes the traveling frequency of the driver of the vehicle 100 with respect to the destination of the vehicle 100, which is input from the destination estimation unit 220, based on the information regarding the traveling history of the vehicle 100 included in the activity history 212, and determines that the destination of the vehicle 100 is a destination frequently traveled by the driver when the traveling frequency is equal to or greater than a predetermined threshold value. When the destination determination unit 240 determines that the destination of the vehicle 100 is a destination frequently traveled by the driver, the destination determination unit 240 specifies the current location of the vehicle 100 based on the information regarding the traveling history of the vehicle 100, which is included as the activity history 212 in the driver information database 210, and then outputs information regarding the current location and destination of the vehicle 100 to a fixed route calculation unit 250.

When the current location of the vehicle 100 input from the destination determination unit 240 is set as a departure point, the fixed route calculation unit 250 calculates a guide route of the vehicle 100 from the departure point of the vehicle 100 toward the destination, as a fixed route 213, based on the Dijkstra method or the like with reference to the map database 230. In this case, the fixed route calculation unit 250 calculates the fixed route 213 based on the static factors of the road environment registered in the map database 230 without considering the dynamic factors of the road environment changing with time. As an example of the static factor of the road environment, a three-dimensional shape of a road can be mentioned. As examples of the dynamic factor of the road environment, congestion information, traffic control information, and accident information can be mentioned. The fixed route 213 is calculated as a route that does not change according to the dynamic factors of the road environment, such as a route on which the traveling distance of the vehicle 100 on the map is the shortest, instead of a route on which the calculation result changes with each calculation due to dynamic factors of the road environment. Then, the fixed route calculation unit 250 stores the calculation result of the fixed route 213, which includes information regarding the departure point, the destination, and the traveling route of the vehicle 100, in the driver information database 210 so as to be associated with the driver ID 211.

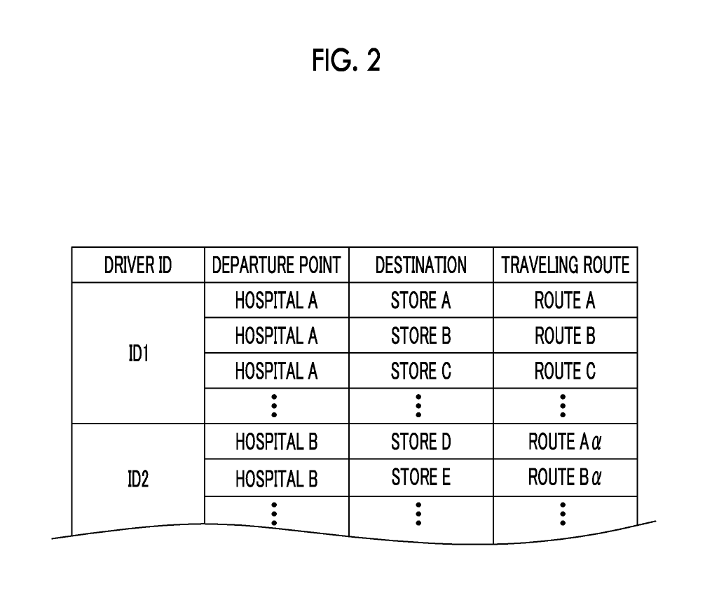

FIG. 2 shows an example of the data content of the fixed route 213 stored in the driver information database 210. In the example shown in FIG. 2, as a part of the fixed route 213 associated with a driver ID “ID1”, “route A”, “route B”, and “route C” are stored as traveling routes when the departure point is “hospital A” and the destination is “store A”, “store B”, or “store C”. In the example shown in FIG. 2, as a part of the fixed route 213 associated with a driver ID “ID2”, “route Aα” and “route Bα” are registered as traveling routes when the departure point is “hospital B” and the destination is “store D” or “store E”. As described above, since facilities frequently traveled by the drivers of the respective vehicles 100 are usually different, the content of the traveling route stored as the fixed route 213 in the driver information database 210 tends to be different for each driver.

Thereafter, when the driver of the vehicle 100 sets the destination through the navigation device 110, the navigation device 110 determines whether or not the driver of the vehicle 100 is a driver who is likely to feel uneasy about his or her memory and for whom presentation of the fixed route 213 is needed, such as an elderly person. For example, in the vehicle, the determination of the driver is realized by registering a driver individual, who is authenticated by using the identification information of the electronic key of the vehicle 100 and the feature quantity of the driver's face as input information in combination, and the necessity of presentation of the fixed route 213 in advance so as to be associated with each other.

Then, when the navigation device 110 determines that the driver of the vehicle 100 is a driver for whom presentation of the fixed route 213 is needed, the navigation device 110 sends a request for a fixed route to the center communication device 201. Then, the center communication device 201 searches for the fixed route 213, which has a combination of a departure point and a destination that matches the combination of the departure point and the destination of the vehicle 100, with reference to the driver information database 210. As a result, when the desired fixed route 213 is found, the center communication device 201 reads information regarding the fixed route 213 from the driver information database 210 and outputs the information to the navigation device 110 through the in-vehicle communication device 130. Then, the navigation device 110 presents the fixed route 213 acquired from the center communication device 201, as a guide route of the vehicle 100, to the driver of the vehicle 100. In this case, for right and left turn intersections or a place where attention is needed on the fixed route 213, the navigation device 110 preferably makes the driver recognize places needing attention together with the fixed route 213 by repeating guidance for right and left turns or warning together with buildings or terrain as a landmark.

On the other hand, when the desired fixed route 213 cannot be found from the driver information database 210, the navigation device 110 calculates the traveling route of the vehicle 100 based on the Dijkstra method or the like with reference to its own map database. Even when the navigation device 110 determines that the driver of the vehicle 100 is not a driver for whom presentation of the fixed route 213 is needed, the navigation device 110 calculates the traveling route of the vehicle 100 based on the Dijkstra method or the like with reference to its own map database. In this case, the navigation device 110 calculates the traveling route of the vehicle 100 in consideration of not only the static factors of the road environment but also the dynamic factors of the road environment dynamically changing when the vehicle 100 travels, such as congestion information, traffic control information, and accident information. When calculating the fixed route 213 in consideration of the dynamic factors of the road environment, the navigation device 110 may perform the calculation based on the presence or absence of the above-described congestion information, traffic control information, and accident information, or may perform the calculation in consideration of the weather, time zone, conditions of the driver, or the like at the time of traveling of the vehicle 100. In the case of the traveling route of the vehicle 100 calculated in this manner, the calculation result changes with each calculation due to the dynamic factors of the road environment. For example, when the traveling route of the vehicle 100 is based only on the static factors of the road environment, such as the three-dimensional shape of the road, a detour that is easily excluded from candidates due to the relatively long traveling distance is also included.

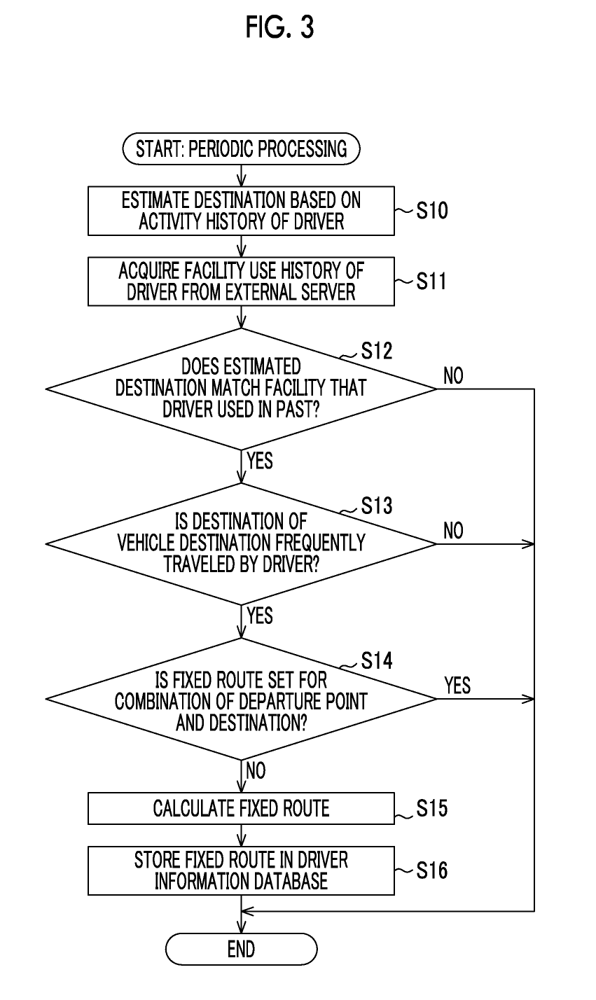

Next, a specific procedure of fixed route calculation processing executed by the management center 200 as the navigation system of the present embodiment will be described. Here, the management center 200 executes fixed route calculation processing shown in FIG. 3 at predetermined periods.

As shown in FIG. 3, in the processing for calculating the fixed route 213, first, the destination estimation unit 220 in the management center 200 estimates the destination of the vehicle 100 based on the activity history 212 of the driver stored in the driver information database 210 (step S10).

Then, the destination estimation unit 220 in the management center 200 acquires the facility use history 310 of the driver from the external server 300 with reference to the driver ID 211 associated with the activity history 212 (step S11).

Then, the destination estimation unit 220 in the management center 200 determines whether or not the destination of the vehicle 100 matches a facility that the driver has used in the past, based on the destination of the vehicle 100 estimated in previous step S10 and the facility use history 310 of the driver acquired in previous step S11 (step S12).

When the destination of the vehicle 100 estimated in previous step S10 does not match the facility that the driver has used in the past (NO in step S12), the management center 200 ends the fixed route calculation processing shown in FIG. 3 without calculating the fixed route 213.

On the other hand, when the destination of the vehicle 100 estimated in previous step S10 matches the facility that the driver has used in the past (YES in step S12), the destination determination unit 240 in the management center 200 determines whether or not the destination of the vehicle 100 is a destination frequently traveled by the driver (step S13).

When the management center 200 determines that the destination of the vehicle 100 is not a destination frequently traveled by the driver (NO in step S13), the management center 200 ends the fixed route calculation processing shown in FIG. 3 without calculating the fixed route 213.

On the other hand, when the management center 200 determines that the destination of the vehicle 100 is a destination frequently traveled by the driver (YES in step S13), the fixed route calculation unit 250 determines, for the combination of the departure point and the destination of the vehicle 100 to be calculated, whether or not the fixed route 213 is set in the driver information database 210 with reference to the driver information database 210 (step S14).

When the fixed route calculation unit 250 determines that the fixed route 213 is already set in the driver information database 210 (YES in step S14), the management center 200 ends the fixed route calculation processing shown in FIG. 3 without calculating the fixed route 213.

On the other hand, when the fixed route calculation unit 250 determines that the fixed route 213 is not set in the driver information database 210 (NO in step S14), the fixed route calculation unit 250 in the management center 200 calculates the fixed route 213 (step S15), stores the calculated fixed route 213 in the driver information database 210 (step S16), and then ends the fixed route calculation processing shown in FIG. 3.

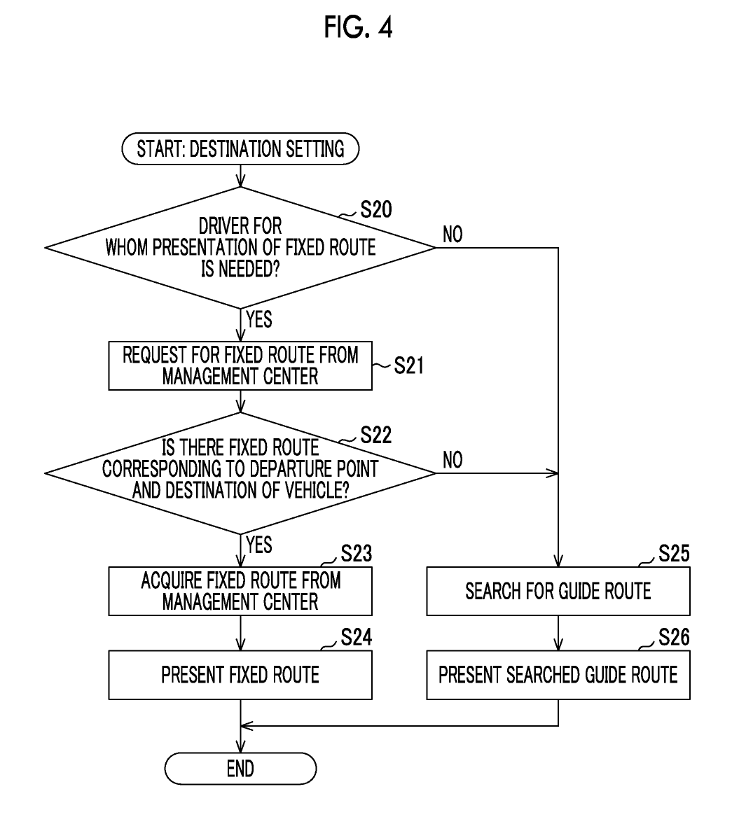

Next, a specific procedure of guide route presentation processing executed by the navigation device 110 mounted in the vehicle 100 in cooperation with the management center 200 as the navigation system of the present embodiment will be described. Here, the navigation device 110 executes the guide route presentation processing shown in FIG. 4 when the destination of the vehicle 100 is set by the driver of the vehicle 100.

As shown in FIG. 4, in the guide route presentation processing, first, the navigation device 110 determines whether or not the driver of the vehicle 100 is a driver for whom presentation of the fixed route 213 is needed (step S20).

When the navigation device 110 determines that the driver of the vehicle 100 is a driver for whom presentation of the fixed route 213 is needed (YES in step S20), the navigation device 110 sends a request for information regarding the fixed route 213 to the center communication device 201 (step S21). In this case, the center communication device 201 searches for the fixed route 213, which has a combination of a departure point and a destination that matches the combination of the departure point and the destination of the vehicle 100, with reference to the driver information database 210.

When the fixed route 213, which has a combination of a departure point and a destination that matches the combination of the departure point and the destination of the vehicle 100, is set in the driver information database 210 (YES in step S22), the navigation device 110 acquires the desired fixed route 213 from the driver information database 210 through the center communication device 201 (step S23). Thereafter, the navigation device 110 presents the fixed route 213 acquired in previous step S23 to the driver as a guide route of the vehicle (step S24), and then ends the guide route presentation processing shown in FIG. 4.

On the other hand, when the driver of the vehicle 100 is a driver for whom presentation of the fixed route 213 is not needed (NO in step S20) or when the fixed route 213 corresponding to the combination of the departure point and the destination of the vehicle 100 is not set in the driver information database 210 (NO in step S22), the navigation device 110 searches for the guide route of the vehicle 100 with reference to its own map database (step S25). When searching for the guide route of the vehicle 100, the navigation device 110 considers not only the static factors of the road environment but also the dynamic factors of the road environment. The navigation device 110 presents the guide route of the vehicle 100 found in previous step S25 to the driver (step S26), and then ends the guide route presentation processing shown in FIG. 4.

Next, the operation of the navigation system of the present embodiment, in particular, the operation of the navigation system when presenting the guide route to the driver of the vehicle 100 in cooperation with the navigation device 110 mounted in the vehicle 100 will be described below.

In general, elderly drivers of the vehicles tend to have a difficulty in accepting new information. For this reason, even if the guide route of the vehicle is presented by the navigation device mounted in the vehicle, it is likely to be difficult for the driver to recognize the traveling of the vehicle along the presented traveling route.

In this regard, in the present embodiment, when the navigation device 110 determines that the traveling of the vehicle 100 by the driver is intended to move toward a facility frequently traveled by the driver, the navigation device 110 reads the fixed route 213 calculated based on the static factors of the road environment from the driver information database 210 of the management center 200 and presents the read fixed route 213 to the driver of the vehicle 100.

In this case, the fixed route 213 is calculated as a route that does not change according to the dynamic factors of the road environment, such as a route on which the traveling distance of the vehicle 100 on the map is the shortest, instead of a route on which the calculation result changes with each calculation due to dynamic factors of the road environment. Therefore, when the combination of the departure point and the destination of the vehicle 100 is the same as the combination of the departure point and the destination stored in the driver information database 210, the navigation device 110 repeatedly presents the same traveling route as the fixed route 213.

Accordingly, even if the driver is an elderly person, the fixed route 213 is repeatedly presented in this manner, so that the traveling route of the vehicle 100 heading for the facility frequently traveled by the driver is learned as a habitual activity. As a result, the driver can continue the driving of the vehicle 100 successfully as long as the driver is in a driving range that the driver is accustomed to.

In the present embodiment, for a driver considered to need no presentation of the fixed route 213, such as a young man, the navigation device 110 presents a traveling route, such as a detour, instead of the fixed route 213 described above while taking into consideration the dynamic factors of the road environment. The traveling route is a route presented in a manner to avoid the dynamic factors of the road environment when the dynamic factors of the road environment that dynamically change at the time of traveling of the vehicle 100, such as traffic congestion, traffic control, and accident, are included in the route at the shortest distance on the map. Therefore, by the presentation of the traveling route, the driver can drive the vehicle 100 while flexibly responding to the traffic situation at that time.

As described above, according to the first embodiment, the following effects can be obtained. (1) In the management center 200, the destination determination unit 240 determines whether or not the destination of the vehicle 100 is a destination frequently traveled by the driver based on the traveling history of the vehicle 100. As a traveling route of the vehicle 100 heading for the destination determined to be a destination frequently traveled by the driver by the destination determination unit 240, the fixed route calculation unit 250 calculates the fixed route 213 based on the static factors of the road environment. Then, the center communication device 201 outputs the fixed route 213 calculated by the fixed route calculation unit 250 to the vehicle 100 as a guide route of the vehicle 100. In this manner, since the fixed route 213 is repeatedly presented as a guide route of the vehicle 100 heading for the destination frequently traveled by the driver of the vehicle 100, the traveling of the vehicle 100 along the fixed route 213 can be suitably recognized by the driver.

(2) In the management center 200, the destination estimation unit 220 estimates the destination of the vehicle 100 based on the activity history of the driver of the vehicle 100. Each time a destination is estimated, the destination determination unit 240 determines whether or not the estimated destination is a destination frequently traveled by the driver. Therefore, compared with a configuration in which the processing for calculating the fixed route 213 is performed exclusively when the destination of the vehicle 100 is actually set, the fixed route 213 is stored in the driver information database 210 for various combinations of the departure point and the destination of the vehicle 100. As a result, since the combination of the departure point and the destination of the vehicle 100 when the destination of the vehicle 100 is set is easy to match the combination of the departure point and the destination of the vehicle 100 on the fixed route 213, the traveling of the vehicle 100 along the fixed route 213 can be recognized by the driver for a wide range of combinations of the departure point and the destination of the vehicle 100.

(3) The navigation device 110 presents the fixed route 213 to the driver as a guide route of the vehicle 100 on condition that the driver of the vehicle 100 is a driver for whom presentation of the fixed route 213 is needed. That is, for a driver who is likely to feel uneasy about his or her memory and for whom presentation of the fixed route 213 is needed, like an elderly person, the fixed route 213 is presented to the driver as a guide route of the vehicle 100 heading for the destination frequently traveled by the driver of the vehicle 100. As a result, the traveling of the vehicle 100 along the fixed route 213 can be recognized by the driver. On the other hand, for a driver considered to need no presentation of the fixed route 213, such as a young man, a detour or the like is presented while taking into consideration the dynamic factors of the road environment that dynamically change at the time of traveling of the vehicle 100. As a result, presentation of the guide route of the vehicle 100 can be flexibly performed.

### Second Embodiment

Next, a second embodiment of the navigation system will be described with reference to the diagrams. The second embodiment is different from the first embodiment in that one or a plurality of fixed routes is calculated for the same combination of a departure point and a destination. Therefore, in the following description, a different configuration from the first embodiment will be mainly described, and the repeated description of the same configuration as in the first embodiment or a configuration corresponding to the first embodiment will be omitted.

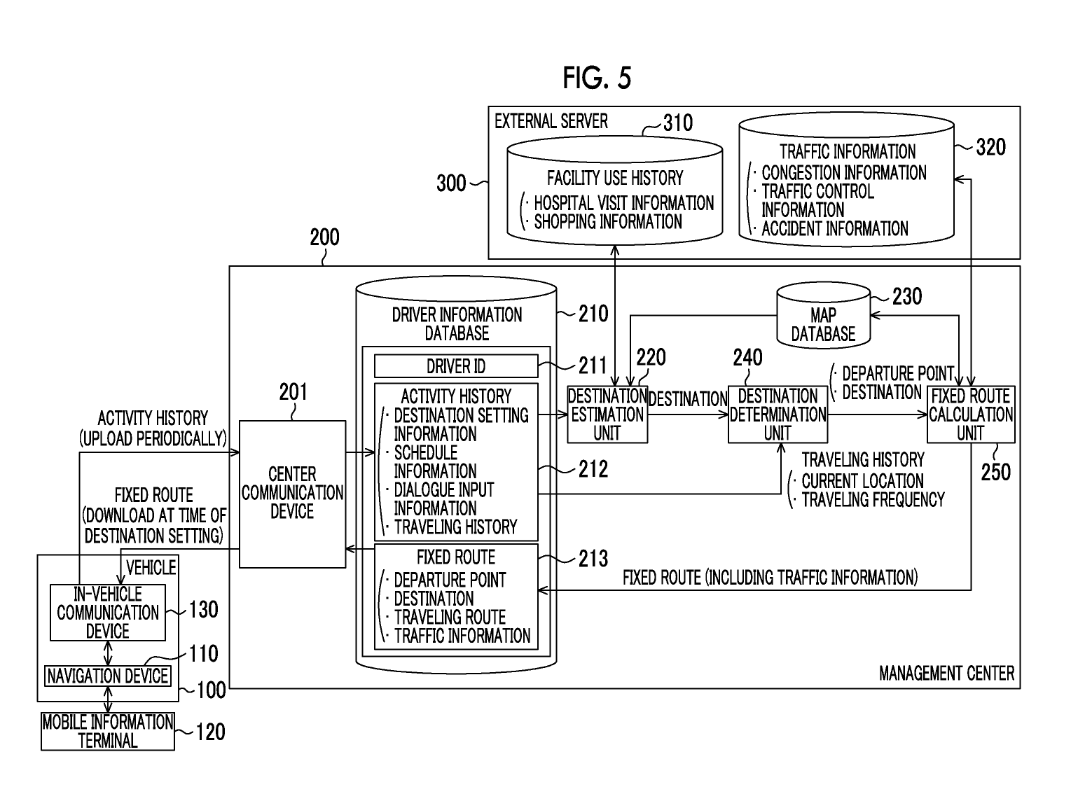

As shown in FIG. 5, in the present embodiment, as in the first embodiment described above, the fixed route calculation unit 250 calculates the fixed route 213 based on the static factors of the road environment registered in the map database 230 without taking into consideration the dynamic factors of the road environment that dynamically change at the time of traveling of the vehicle 100. In addition, when calculating the fixed route 213, the fixed route calculation unit 250 acquires traffic information 320, such as congestion information, traffic control information, and accident information on the fixed route 213, from the external server 300. Then, the fixed route calculation unit 250 stores the fixed route 213 calculated as described above in the driver information database 210 so as to be associated with the traffic information 320 acquired from the external server 300.

After the destination is set by the driver of the vehicle 100, when the navigation device 110 determines that the driver is a driver for whom presentation of the fixed route 213 is needed, the navigation device 110 sends a request for a fixed route to the center communication device 201 through the in-vehicle communication device 130. Then, the center communication device 201 searches for the fixed route 213, which has a combination of a departure point and a destination that matches the combination of the departure point and the destination of the vehicle 100, with reference to the driver information database 210. As a result, when the desired fixed route 213 is found, the center communication device 201 reads information regarding the fixed route 213 from the driver information database 210 and outputs the read fixed route 213 to the in-vehicle communication device 130 together with the guide route of the vehicle 100.

When calculating the fixed route 213, the fixed route calculation unit 250 searches for the fixed route 213 corresponding to the combination of the departure point and the destination to be calculated, among the fixed routes 213 registered in the driver information database 210, with reference to the driver information database 210. Then, the fixed route calculation unit 250 calculates the fixed route 213 when there is no fixed route 213 for the corresponding combination. Even if there is a fixed route 213 for the corresponding combination, when the fixed route 213 is associated with traffic information, the fixed route calculation unit 250 newly calculates the fixed route 213 for the same combination of the departure point and the destination. That is, the fixed route calculation unit 250 calculates a first fixed route, as a traveling route of the vehicle 100 from the departure point toward the destination, based on the static factors of the road environment, and calculates a second fixed route different from the first fixed route when the first fixed route is associated with traffic information.

When calculating the second fixed route, in the same manner as when calculating the first fixed route, the fixed route calculation unit 250 performs the calculation based on the static factors of the road environment registered in the map database 230 without taking into consideration the dynamic factors of the road environment that dynamically change at the time of traveling of the vehicle 100. That is, similarly to the first fixed route, the second fixed route is not a route on which the calculation result changes with each calculation due to dynamic factors of the road environment, and is a route that does not change according to the dynamic factors of the road environment. However, for example, when a route on which the traveling distance of the vehicle 100 on the map is the shortest is calculated as the first fixed route, the fixed route calculation unit 250 calculates the second fixed route as a route different from the first fixed route, such as calculating a route on which the traveling distance of the vehicle 100 on the map is the second shortest as the second fixed route.

Then, when there is a plurality of fixed routes 213 having a combination of a departure point and a destination that matches the combination of the departure point and the destination of the vehicle 100, the center communication device 201 determines the ease of traveling of the vehicle 100 based on the dynamic factors of the road environment for the plurality of fixed routes 213. The center communication device 201 reads the fixed route 213, which is determined that the vehicle 100 tends to travel easily, from the driver information database 210, and outputs the read fixed route 213 to the in-vehicle communication device 130 as a guide route of the vehicle 100.

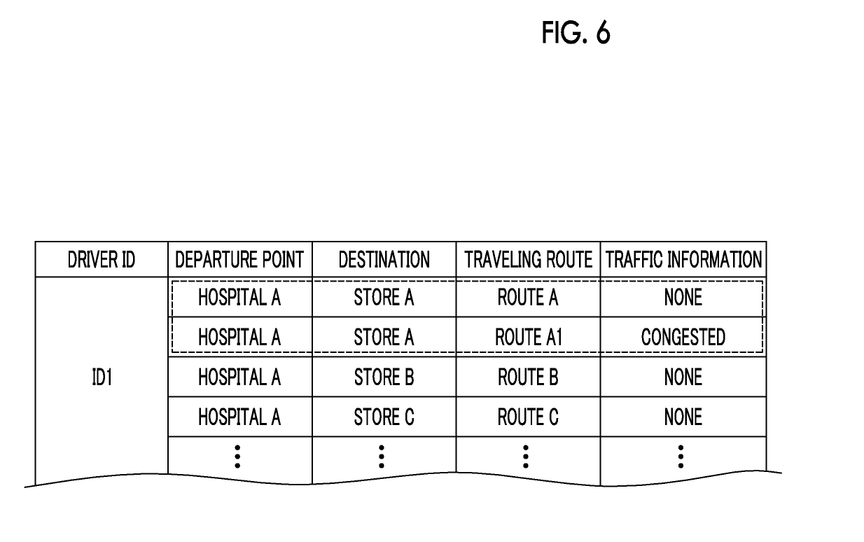

FIG. 6 shows an example of the data content of the fixed route 213 stored in the driver information database 210. In the example shown in FIG. 6, as a part of the fixed route 213 associated with a driver ID “ID1”, “route A” and “route A1” are registered as traveling routes when the departure point is “hospital A” and the destination is “store A”. That is, in the example shown in FIG. 6, a plurality of traveling routes is registered for the same combination of a departure point and a destination. “None” is associated as “traffic information” in “route A”, and “congested” is associated as “traffic information” in “route A1”. Therefore, in this example, when the departure point of the vehicle 100 is “hospital A” and “store A” is set as the destination of the vehicle 100, “route A” determined that the vehicle 100 tends to travel easily is presented to the driver as a guide route of the vehicle 100 based on the traffic information of each route.

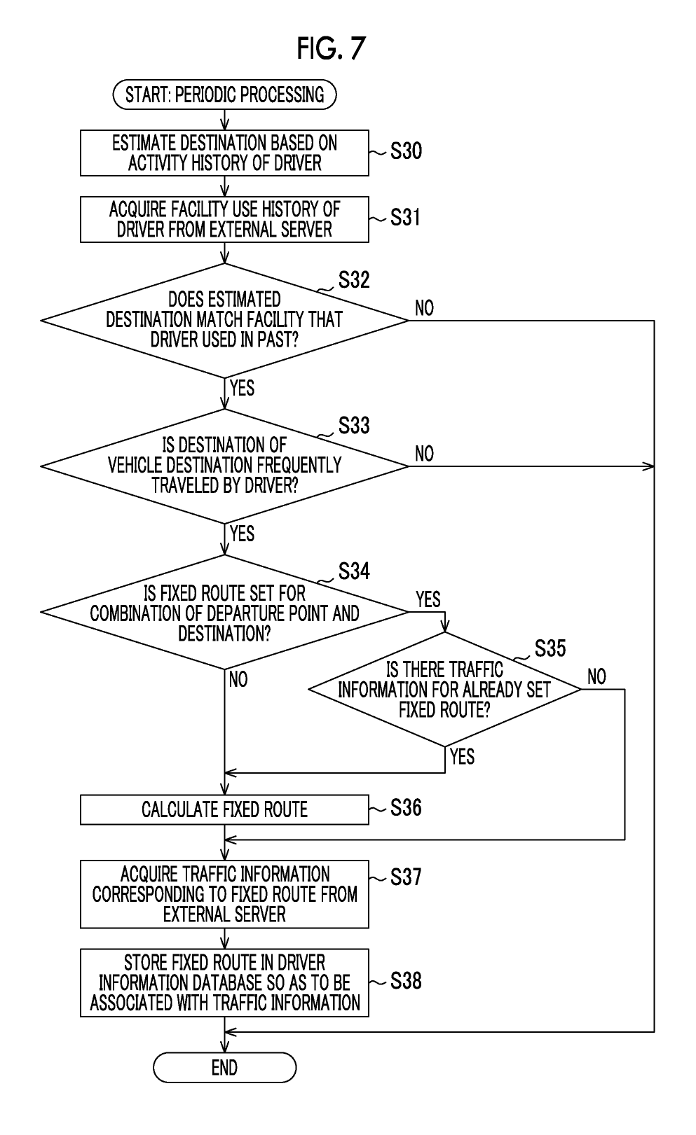

Next, a specific procedure of fixed route calculation processing executed by the management center 200 as the navigation system of the present embodiment will be described. Here, the management center 200 executes fixed route calculation processing shown in FIG. 7 at predetermined periods.

As shown in FIG. 7, in the fixed route calculation processing, in steps S30 to S34, the fixed route calculation unit 250 in the management center 200 determines, for the combination of the departure point and the destination of the vehicle 100 to be calculated, whether or not the fixed route 213 is set in the driver information database 210 with reference to the driver information database 210, in the same manner as in the processing of steps S10 to S14 in FIG. 3 in the first embodiment.

When the fixed route calculation unit 250 in the management center 200 determines that the fixed route 213 is not set in the driver information database 210 for the combination of the departure point and the destination of the vehicle 100 to be calculated (NO in step S34), the fixed route calculation unit 250 calculates the fixed route 213 (step S36). On the other hand, when the fixed route calculation unit 250 in the management center 200 determines that the fixed route 213 is already set in the driver information database 210 for the combination of the departure point and the destination of the vehicle 100 to be calculated (YES in step S34), the fixed route calculation unit 250 determines whether or not the already set fixed route 213 is associated with traffic information (step S35). When the fixed route calculation unit 250 in the management center 200 determines that the already set fixed route 213 is associated with traffic information (YES in step S35), the fixed route calculation unit 250 calculates a new fixed route 213. On the other hand, when “None” is associated with the already set fixed route 213 as traffic information (NO in step S35), the management center 200 does not calculate the fixed route 213, and the process proceeds to step S37.

Thereafter, the management center 200 acquires the traffic information 320 corresponding to the fixed route 213 from the external server 300 (step S37). Then, the management center 200 stores the traffic information 320 acquired as described above in the driver information database 210 so as to be associated with the fixed route 213 (step S38), and then ends the fixed route calculation processing shown in FIG. 7.

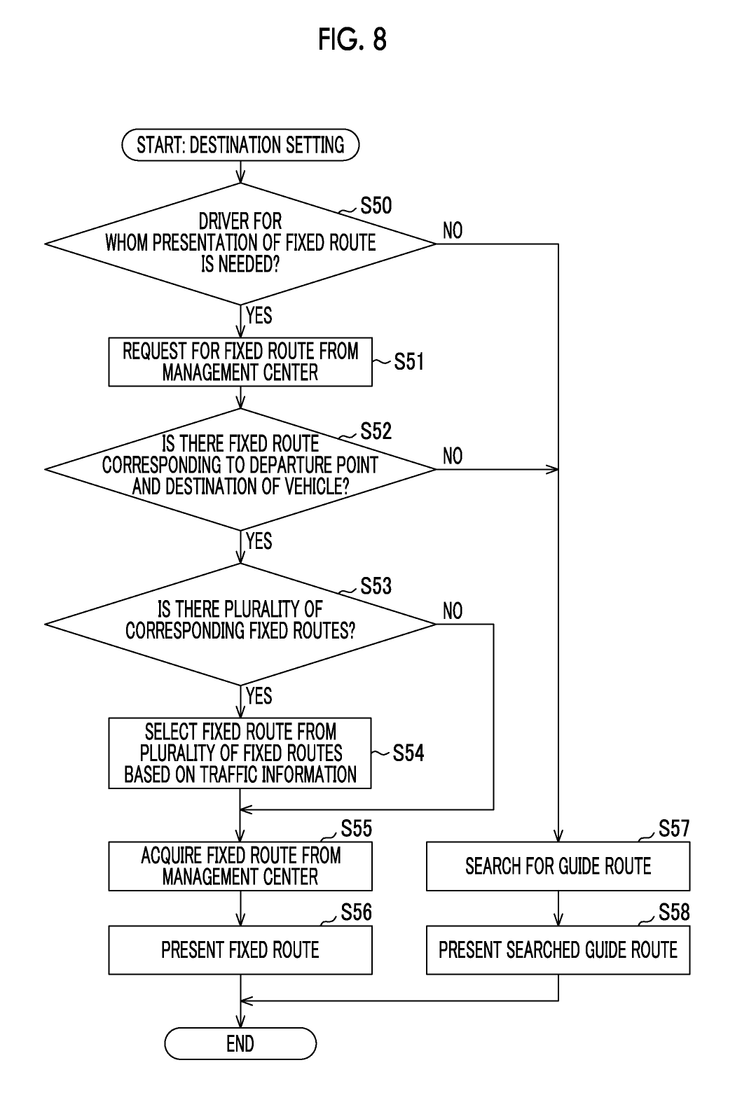

Next, a specific procedure of guide route presentation processing executed by the navigation device 110 mounted in the vehicle 100 in cooperation with the management center 200 as the navigation system of the present embodiment will be described. Here, the navigation device 110 executes the guide route presentation processing shown in FIG. 8 when the destination of the vehicle 100 is set by the driver of the vehicle 100.

As shown in FIG. 8, in the guide route presentation processing, first, in steps S50 to S52, the navigation device 110 sends a request for the fixed route 213, which has a combination of a departure point and a destination that matches the combination of the departure point and the destination of the vehicle 100, to the center communication device 201, in the same manner as in the processing of steps S20 to S22 in FIG. 4 in the first embodiment. Then, the center communication device 201 determines whether or not the corresponding fixed route 213 is set in the driver information database 210.

When there is a plurality of fixed routes 213 having a combination that matches the combination of the departure point and the destination of the vehicle 100 (YES in step S53), the center communication device 201 selects the fixed route 213 from the plurality of fixed routes 213 based on the traffic information 320 associated with the fixed route (step S54).

Then, the center communication device 201 acquires the fixed route 213 selected in previous step S54 from the driver information database 210 (step S55), and outputs the acquired fixed route 213 to the navigation device 110. Then, the navigation device 110 presents the fixed route 213 acquired from the center communication device 201 to the driver as a guide route of the vehicle 100 (step S56), and then ends the guide route presentation processing shown in FIG. 8.

On the other hand, when there is one fixed route 213 having a combination that matches the combination of the departure point and the destination of the vehicle 100 (NO in step S53), the center communication device 201 acquires the fixed route 213 from the driver information database 210 (step S55). Then, the center communication device 201 outputs the fixed route 213 acquired as described above to the navigation device 110. Then, the navigation device 110 presents the fixed route 213 acquired from the center communication device 201 to the driver as a guide route of the vehicle 100 (step S56), and then ends the guide route presentation processing shown in FIG. 8.

As in the first embodiment, when the driver of the vehicle 100 is a driver for whom presentation of the fixed route 213 is not needed (NO in step S50) or when the fixed route 213 corresponding to the combination of the departure point and the destination of the vehicle 100 is not set in the driver information database 210 (NO in step S52), the navigation device 110 searches for the guide route of the vehicle 100 with reference to its own map database (step S57). When searching for the guide route of the vehicle 100, the navigation device 110 considers not only the static factors of the road environment but also the dynamic factors of the road environment. The navigation device 110 presents the guide route of the vehicle 100 found in previous step S57 to the driver (step S58), and then ends the guide route presentation processing shown in FIG. 8.

Next, the operation of the navigation system of the present embodiment, in particular, the operation of the navigation system when presenting the guide route to the driver of the vehicle 100 in cooperation with the navigation device 110 mounted in the vehicle 100 will be described below.

In general, an elderly driver of the vehicle 100 tends to have difficulty in accepting new information. For this reason, even if the guide route of the vehicle 100 is presented by the navigation device 110, it is likely to be difficult for the driver to recognize the traveling of the vehicle 100 along the presented traveling route. For example, in a situation in which there are traffic controls on the road through which the driver usually travels and exclusively a sign saying “under construction” is standing, such a driver may feel the road as a different road and be confused.

In this regard, in the present embodiment, when a plurality of fixed routes 213 corresponding to the combination of the departure point and the destination of the vehicle 100 is set in the driver information database 210 of the management center 200, the center communication device 201 determines the ease of traveling of the vehicle 100 based on the dynamic factors of the road environment for the plurality of fixed routes 213. Then, the center communication device 201 reads the fixed route 213, which is determined that the vehicle 100 tends to travel relatively easily, from the driver information database 210, and outputs the read fixed route 213 to the navigation device 110. Then, the navigation device 110 presents the fixed route 213 received from the center communication device 201, as a guide route of the vehicle 100, to the driver of the vehicle 100. As a result, the fixed route 213, on which the impression given to the driver each time the vehicle 100 travels is hardly changed, is presented to the driver as the guide route of the vehicle 100. In addition, according to such presentation of the guide route of the vehicle 100, the traveling of the vehicle 100 along the fixed route 213 can be suitably recognized by the above-described driver.

As described above, according to the second embodiment, in addition to the effects of the first embodiment, the following effects can be obtained. (4) The fixed route calculation unit 250 in the management center 200 calculates one or a plurality of fixed routes 213, as a traveling route of the vehicle 100 from the departure point toward the destination when the destination determination unit 240 determines that the destination of the vehicle 100 is a destination frequently traveled by the driver, based on the static factors of the road environment, and stores the one or the plurality of fixed routes 213 in the driver information database 210. When a plurality of fixed routes 213 is stored in the driver information database 210 as traveling routes of the vehicle 100 from the departure point toward the destination when the destination of the vehicle 100 is set, the center communication device 201 determines the ease of traveling of the vehicle 100 based on the traffic information 320 for the plurality of fixed routes 213. The center communication device 201 reads the fixed route 213, which is determined that the vehicle 100 tends to travel relatively easily, from the driver information database 210, and outputs the read fixed route 213 to the navigation device 110 mounted in the vehicle 100. As a result, since the fixed route 213, on which the impression given to the driver each time the vehicle 100 travels is hardly changed, is presented to the driver, the traveling of the vehicle 100 along the presented fixed route 213 can be suitably recognized by the driver.

### Other Embodiments

Each of the above embodiments can also be implemented in the following forms.

In the second embodiment described above, the fixed route calculation unit 250 calculates a first fixed route, as a traveling route of the vehicle 100 from the departure point toward the destination, based on the static factors of the road environment, and calculates a second fixed route different from the first fixed route when the first fixed route is associated with traffic information. Instead, the fixed route calculation unit 250 may calculate a first fixed route, as a traveling route of the vehicle 100 from the departure point toward the destination, based on the static factors of the road environment and calculate a second fixed route different from the first fixed route when the read frequency of the first fixed route reaches a predetermined threshold value.

According to the above configuration, various fixed routes 213 as traveling routes of the vehicle 100 heading for the destination determined to be frequently traveled by the driver can be sequentially recognized by the driver.

In each of the above embodiments, the navigation device 110 periodically uploads the activity history 212 of the driver of the vehicle 100 to the management center 200. Instead, the navigation device 110 may determine in advance whether or not the driver of the vehicle 100 is a driver for whom presentation of the fixed route 213 is needed, and uploads the activity history 212 of the driver to the management center 200 on condition that the navigation device 110 determines that the driver of the vehicle 100 is a driver for whom presentation of the fixed route 213 is needed.

In each of the above embodiments, the navigation device 110 may uniformly present the fixed route 213 to the driver without performing processing for determining whether or not the driver of the vehicle 100 is a driver for whom presentation of the fixed route 213 is needed.

In the second embodiment described above, the fixed route calculation unit 250 calculates the first fixed route based on the static factors of the road environment first, and calculates the second fixed route different from the first fixed route when the first fixed route is associated with traffic information. Instead, the fixed route calculation unit 250 may calculate a plurality of fixed routes 213 having different calculation conditions in parallel based on the static factors of the road environment without considering the traffic information associated with the fixed route 213.

In the second embodiment described above, the management center 200 acquires the traffic information 320 relevant to the fixed route 213 calculated by the fixed route calculation unit 250 from the external server 300, and stores the acquired traffic information 320 in the driver information database 210 so as to be associated with the fixed route 213. Instead, the management center 200 may acquire the traffic information 320 relevant to the fixed route 213 from the external server 300 when the navigation device 110 mounted in the vehicle 100 reads the fixed route 213 from the management center 200, without managing the traffic information 320 relevant to the fixed route 213.

In the second embodiment described above, when a plurality of fixed routes 213 is set in the driver information database 210 for the combination of the departure point and the destination of the vehicle 100, the center communication device 201 selects the fixed route 213 based on the traffic information 320 associated with the plurality of fixed routes 213. Instead, the center communication device 201 may select one of the plurality of fixed routes 213 with reference to an evaluation value based on the static factors of the road environment, such as a traveling distance on the map.

In each of the above embodiments, the destination estimation unit 220 inputs information regarding the estimated destination to the destination determination unit 240 on condition that the destination estimated based on the activity history of the driver matches a facility determined to have been used by the driver in the past based on the facility use history 310 of the driver, and the destination determination unit 240 determines whether or not the destination estimated based on the activity history of the driver is a destination frequently traveled by the driver. Instead, as long as the destination estimation precision can be secured, the destination estimation unit 220 may input the information regarding the destination estimated based on the activity history of the driver as it is to the destination determination unit 240, and the destination determination unit 240 may determine whether or not the destination estimated based on the activity history of the driver is a destination frequently traveled by the driver. Alternatively, exclusively when the destination is actually set by the navigation device 110, determination regarding whether or not the set destination is a destination frequently traveled by the driver may be made without estimating the destination based on the activity history of the driver.

In each of the above embodiments, the management center 200 stores the activity history of the driver, which is periodically uploaded from the vehicle 100, in the driver information database 210, and estimates the destination of the vehicle 100 based on the stored activity history of the driver. Instead, the activity history of the driver may be stored in a vehicle side database mounted on the vehicle 100, and the vehicle 100 side may mainly estimate the destination of the vehicle 100 based on the stored activity history of the driver.

In each of the above embodiments, the management center 200 estimates the destination of the vehicle 100 based on the activity history of the driver stored in the driver information database 210, calculates the fixed route 213 as a traveling route of the vehicle 100 headed for the destination estimated at that time, and stores the calculated fixed route 213 in the driver information database 210. Instead, exclusively when the destination of the vehicle 100 is set by the navigation device 110 mounted in the vehicle 100, the navigation device 110 may request the management center 200 to calculate the fixed route 213, and the fixed route 213 obtained by the above calculation may be output from the management center 200 to the navigation device 110, without storing the fixed route 213.

In each of the above embodiments, the navigation system is configured to include the management center 200, and the management center 200 calculates the fixed route 213 based on the static factors of the road environment. Instead, the navigation system may be a system mounted in the vehicle 100, and the navigation device 110 mounted in the vehicle 100 may mainly calculate the fixed route 213 based on the static factors of the road environment with reference to its own map database.

What is claimed is:

1. A navigation system, comprising:
a destination determination unit configured to determine whether or not a destination of a vehicle is a destination frequently traveled by a driver of the vehicle based on a traveling history of the vehicle;
a fixed route calculation unit configured to calculate a fixed route that is a route based on static factors, among the static factors that do not change with time and dynamic factors that change with time, all of which are factors that determine a road environment, as a traveling route of the vehicle from a departure point toward a destination when the destination determination unit determines that the destination of the vehicle is the destination frequently traveled by the driver of the vehicle; and
a route output unit configured to output the fixed route calculated by the fixed route calculation unit to a route display device as a guide route of the vehicle.

2. The navigation system according to claim 1, further comprising:
a destination estimation unit configured to estimate a destination of the vehicle based on an activity history of the driver of the vehicle; and
a fixed route storage unit configured to store the fixed route calculated by the fixed route calculation unit, wherein:
the destination determination unit is configured to determine whether or not the estimated destination is the destination frequently traveled by the driver each time destination estimation is performed by the destination estimation unit;
the fixed route calculation unit is configured to store the fixed route in the fixed route storage unit as a traveling route of the vehicle from the departure point toward the destination when the destination determination unit determines that the destination estimated by the destination estimation unit is the destination frequently traveled by the driver; and
the route output unit is configured to read the fixed route from the fixed route storage unit and output the read fixed route as a guide route of the vehicle when a combination of a departure point and a destination when a destination of the vehicle is set by the driver of the vehicle matches a combination of a departure point and a destination of the vehicle in the fixed route stored in the fixed route storage unit.

3. The navigation system according to claim 2, wherein:
the fixed route calculation unit is configured to store the fixed route or a plurality of the fixed routes based on the static factors in the fixed route storage unit as a traveling route of the vehicle from the departure point toward the destination when the destination determination unit determines that the destination of the vehicle is the destination frequently traveled by the driver, and
the route output unit is configured to determine ease of traveling of the vehicle based on the dynamic factors for the plurality of the fixed routes, read the fixed route determined to be relatively easy in traveling from the fixed route storage unit, and output the read fixed route as a guide route of the vehicle when the plurality of the fixed routes is stored in the fixed route storage unit as traveling routes of the vehicle from the departure point toward the destination when the destination of the vehicle is set by the driver of the vehicle.

4. The navigation system according to claim 3, wherein the dynamic factors for the plurality of the fixed routes are traffic information in each of the plurality of the fixed routes, and include at least one of congestion information, traffic control information, and accident information.

5. The navigation system according to claim 2, wherein the fixed route calculation unit is configured to calculate a first fixed route, as a traveling route of the vehicle from the departure point toward the destination when the destination determination unit determines that the destination of the vehicle is the destination frequently traveled by the driver, based on the static factors, and calculate a second fixed route different from the first fixed route based on the static factors when a frequency of reading the first fixed route by the route output unit reaches a predetermined threshold value.

6. The navigation system according to claim 1, wherein the traveling history of the vehicle is periodically uploaded from the vehicle to a driver information database.

7. A control method for a navigation system, the control method comprising:
estimating a destination of a vehicle based on an activity history of a driver of the vehicle that is stored in a driver information database;
acquiring a facility use history of the driver from an external server;
determining whether or not the estimated destination of the vehicle is a destination frequently traveled by the driver of the vehicle;
calculating a fixed route that is a route based on static factors, among the static factors that do not change with time and dynamic factors that change with time, all of which are factors that determine a road environment, as a traveling route of the vehicle from a departure point toward a destination when the estimated destination of the vehicle is determined to be the destination frequently traveled by the driver of the vehicle; and
storing the fixed route in the driver information database.

8. The control method according to claim 7, further comprising:
determining whether or not the driver is a driver for whom presentation of a fixed route is needed; and
in a case where the driver is a driver for whom presentation of the fixed route is needed, when there is a fixed route corresponding to the departure point and the destination of the vehicle, acquiring the fixed route and presenting the fixed route to the driver.

9. The control method according to claim 8, further comprising:
determining whether or not there is a plurality of fixed routes corresponding to the destination;
acquiring traffic information corresponding to each fixed route from an external server in a case where there is a plurality of fixed routes corresponding to the destination; and
selecting a fixed route from the plurality of fixed routes based on the traffic information, acquiring the selected fixed route from the driver information database, and presenting the acquired fixed route to the driver.
